(19) United States
(12) Patent Application Publication
(10) Pub. No.: US 2014/0129280 A1
(43) Pub. Date: May 8, 2014

(54) Smart Packaging Initiative (SPI) Scoring System

(71) Applicant: DISNEY ENTERPRISES, INC., Burbank, CA (US)

(72) Inventors: Candela Montero, Los Angeles, CA (US); Leonard J. Mazzocco, Glendale, CA (US); Elaine DeHoyos, Woodland Hills, CA (US); Christian Del Maestro, Glendale, CA (US); Robert Vos, South Pasadena, CA (US)

(73) Assignee: Disney Enterprises, Inc., Burbank, CA (US)

(21) Appl. No.: 13/671,413

(22) Filed: Nov. 7, 2012

(51) Int. Cl. G06Q 10/06

(52) U.S. Cl. CPC G06Q 10/0631
USPC 705/7.23

(57) ABSTRACT

A method is provided for the smart packaging initiative (SPI) scoring system, with particular relevance for the toy industry. The SPI scoring system may include at least four indicators, including carbon footprint of packaging on a life-cycle basis, materials health on a life-cycle basis, waste-to-landfill measurement, and cube utilization. By using a SPI classification system, products can be placed in classes with very similar functional packaging requirements, regardless of the specific toy genre or traditional retail classification of the product. Accordingly, by utilizing data available for existing products in the industry, a baseline environmental norm for packaging categories can be established, providing a useful reference point for improvement. Further, the SPI scoring system can also support comparisons of multiple packaging scenarios for the same product, allowing users to refine their package designs towards environmentally preferable design changes.

### BACKGROUND

For companies to meet environmental and sustainability goals now and into the future, it is desirable to understand the environmental performance and impact of present and future product designs. While some environmental scoring systems already exist, there is a need for an environmental scoring system that is specifically tailored to the various requirements of specific industries, such as the toy industry.

### SUMMARY

The present disclosure is directed to the smart packaging initiative (SPI) scoring system, substantially as shown in and/or described in connection with at least one of the figures, as set forth more completely in the claims.

### BRIEF DESCRIPTION OF THE DRAWINGS

FIG. 1 presents an exemplary diagram of a system for providing the smart packaging initiative (SPI) scoring system;

FIG. 2A presents an exemplary project management user interface of the smart packaging initiative (SPI) scoring system;

FIG. 2B presents an exemplary data entry user interface of the smart packaging initiative (SPI) scoring system;

FIG. 2C presents another exemplary data entry user interface of the smart packaging initiative (SPI) scoring system;

FIG. 2D presents an exemplary score report interface of the smart packaging initiative (SPI) scoring system;

FIG. 3 presents an exemplary flowchart illustrating a method by which a user interface for the smart packaging initiative (SPI) scoring system may be provided.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

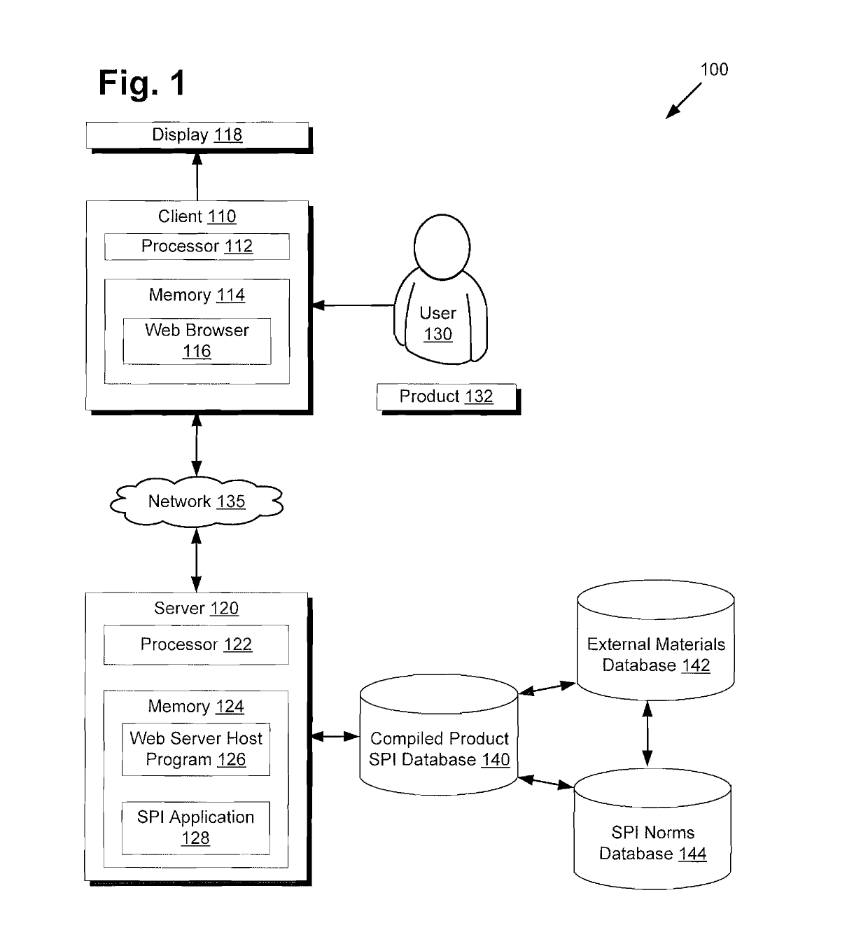

While environmental scoring systems exist for general purpose product planning, these systems often fail to consider the impact of a product throughout its entire lifetime, and often provide little functionality beyond general data storage and simple queries. Accordingly, FIG. 1 presents an exemplary diagram of a system for providing the smart packaging initiative (SPI) scoring system. Diagram 100 of FIG. 1 includes client 110, display 118, server 120, user 130, product 132, network 135, compiled product SPI database 140, external materials database 142, and SPI norms database 144. Client 110 includes processor 112 and memory 114. Memory 114 includes web browser 116. Server 120 includes processor 122 and memory 124. Memory 124 includes web server host program 126 and SPI application 128.

Diagram 100 illustrates a simplified topology for a web-based SPI application 128, which provides user access to the SPI scoring system. Accordingly, only a single client 110 and a single server 120 are shown. However, alternative implementations may support a much larger number of clients and may provide multiple servers for load balancing and/or reduced latency. Furthermore, additional support structures may be provided for authentication and security, which are not shown in FIG. 1. Client 110 and server 120 may be any computing device, such as a desktop computer, laptop computer, tablet, or another device. Network 135 may be a private intranet or a public network such as the Internet, and may provide data links between client 110 and server 120.

User 130 may be an internal company employee, outside contractor, licensee, or another person authorized to access SPI application 128. During the packaging design phase for product 132, user 130 may be required to use SPI application 128 to generate and submit a SPI score report for review and analysis of company environmental goals. Accordingly, user 130 may utilize web browser 116 executing on processor 112 of client 110 to access web server host program 126 executing on processor 122 of server 120. Web server host program 126 may then provide web browser 116 access to SPI application 128, which may show a user interface on display 118, populated with data available in compiled product SPI database 140 and external materials database 142. As described herein, a database, such as compiled product SPI database 140, external materials database 142, and/or SPI norms database 144, may refer to data storage or a module including data storage and data processing.

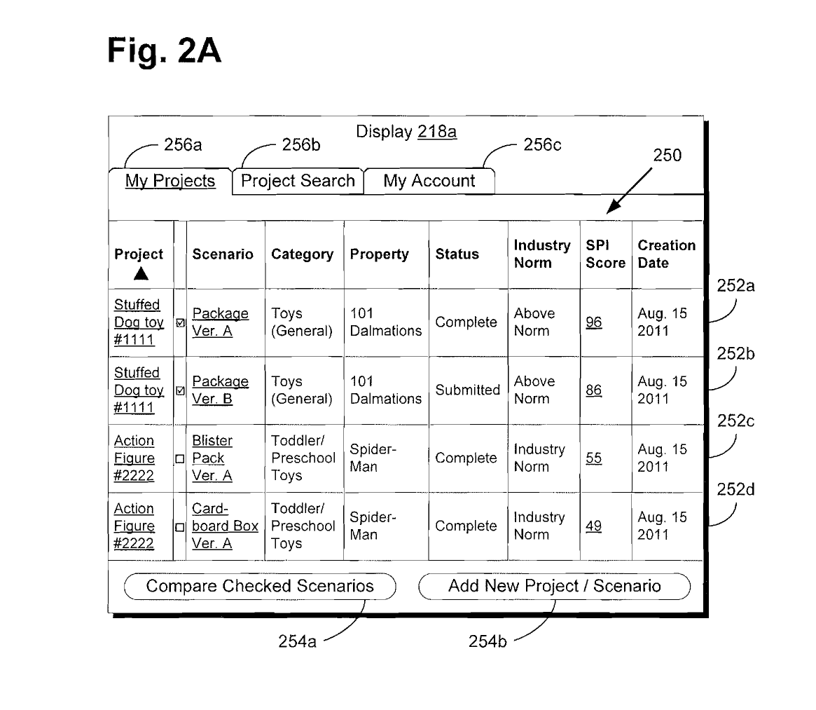

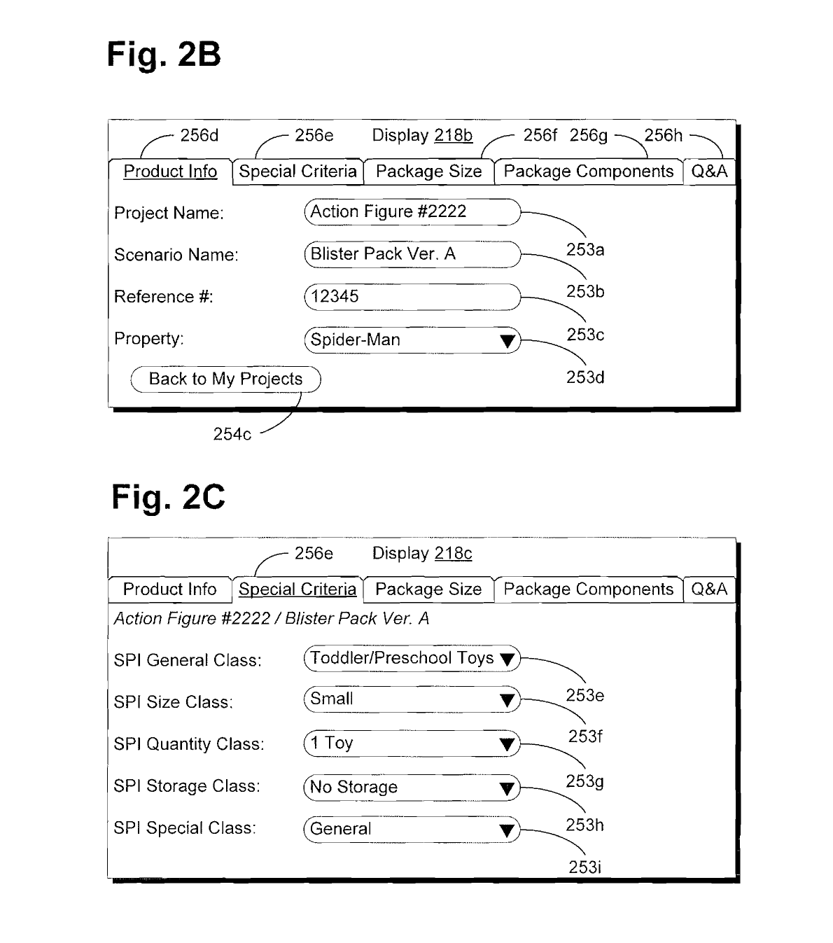

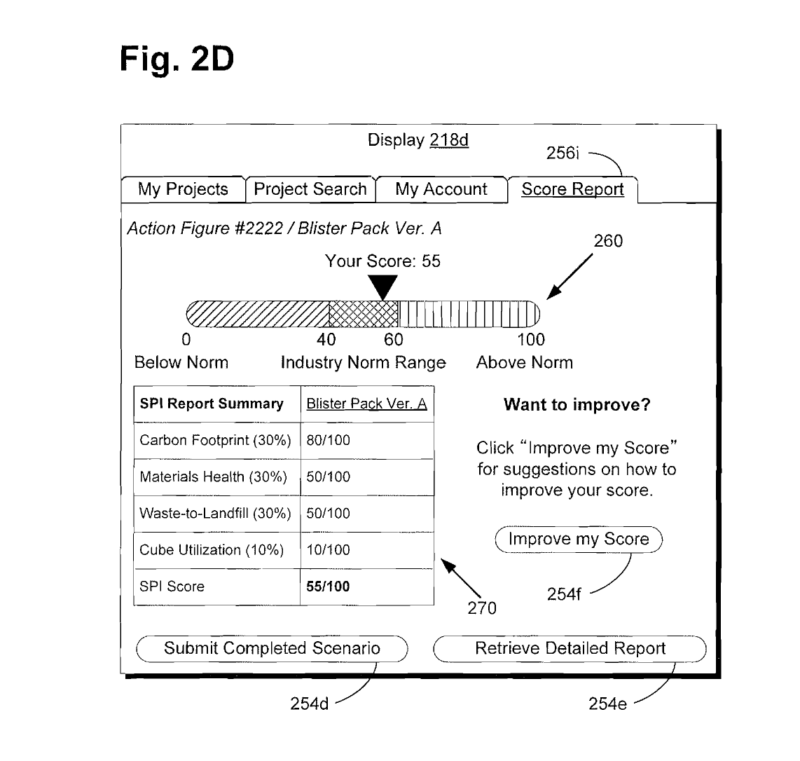

FIG. 2A presents an exemplary project management user interface of the smart packaging initiative (SPI) scoring system. Display 218a of FIG. 2A includes tabbed windows 256a, 256b, and 256c. Tabbed window 256a includes table 250 and buttons 254a and 254b. Table 250 includes data records 252a, 252b, 252c, and 252d. With respect to FIG. 2A, display 218a may correspond to display 118 from FIG. 1.

After accessing a login page and providing valid credentials, user 130 may be greeted with an interface similar to that depicted on display 218a. Tabbed window 256a, or “My Projects” may be presented to user 130 by default, showing a table 250 populated with all product packaging projects associated with user 130. Product packaging project information may be available from compiled product SPI database 140. Tabbed window 256b, or “Project Search” may allow user 130 to search within table 250 for a specific project, or to search for projects by other users, according to permissions granted to user 130. For example, some projects may be marked as private and only viewable by the owner, whereas other projects are marked as public and freely viewable. Tabbed window 256c, or “My Account” may allow user 130 to set application preferences and defaults such as measurement units, to change account settings such as e-mail notifications, and to logout.

Focusing on table 250, all projects owned by user 130 are listed in tabular format. Each header column of table 250 may be clicked to sort table 250 by that column in ascending or descending order. As shown in table 250, the “Project” column is currently being used as a sorting column in descending or reverse alphabetical order.

To define the header columns of table 250, “Project” refers to a product packaging project associated with one stock-keeping unit (SKU) or a range of SKUs. “Scenario” refers to a specific packaging configuration associated with a project, allowing a user to specify multiple alternative packaging designs for a single product. “Category” summarizes the general or special SPI categorization of the product and package design, explained in further detail below. “Property” shows the associated intellectual property or product franchise for the product. “Status” shows the current completion status of the scenario. “Industry norm” compares the calculated SPI score of the scenario to the average performance of the industry in similar products, as further described below. “SPI score” shows the calculated SPI score of the product packaging scenario, showing an easy to understand numerical score from 0 to 100, where higher scores are more environmentally friendly. “Creation date” shows the date when the scenario was created.

By marking the checkbox next to specific scenarios and clicking button 254a, user 130 can compare the SPI score reports of the specific scenarios, allowing user 130 to weigh the advantages and disadvantages of each scenario. By clicking on button 254b, user 130 may define additional new projects and add new scenarios for existing projects. Otherwise, user 130 may click on an existing project or scenario within table 250 for viewing or editing.

Assuming user 130 clicks on data record 252c, display 218a may transition to a user interface similar to that shown in display 218b of FIG. 2B. FIG. 2B presents an exemplary data entry user interface of the smart packaging initiative (SPI) scoring system. Display 218b of FIG. 2B includes tabbed windows 256d, 256e, 256f, 256g, and 256h. Tabbed window 256d includes data entry fields 253a, 253b, 253c, 253d, and button 254c. With respect to FIG. 2B, display 218b may correspond to display 118 from FIG. 1.

As shown in display 218b, tabbed window 256d or “Product Info” may open automatically by default, providing data entry fields 253a-253d for viewing and editing by user 130. Tabbed window 256e or “Special Criteria” may allow user 130 to edit product classifications and other data. Tabbed window 256f or package size may allow user 130 to specify the physical dimensions of the product, including cube utilization and units per master carton. Tabbed window 256g or package components may allow user 130 to specify the packaging components and their material makeup. If user 130 wishes to work on a different scenario or project, button 254c may be clicked to return to the interface shown in FIG. 2A.

Examining tabbed window 256d, data entry fields 253a-253d are presented for viewing and editing. Data entry field 253a allows the editing of the project name, which may preferably be a unique name. Data entry field 253b allows the editing of the scenario name, which again may preferably be a unique name. Data entry field 253c allows the editing of a reference number, which may be an internal company identifier and may also preferably be unique. Data entry field 253d allows the editing of the associated property by using a drop-down menu to select the appropriate licensed property.

Assuming user 130 clicks on tabbed window 256e, display 218b may transition to a user interface similar to that shown in display 218c of FIG. 2C. FIG. 2C presents another exemplary data entry user interface of the smart packaging initiative (SPI) scoring system. Display 218c of FIG. 2C includes tabbed window 256e, which includes data entry fields 253e, 253f, 253g, 253h, and 253i. With respect to FIG. 2C, display 218c may correspond to display 118 from FIG. 1.

Examining tabbed window 256e, data entry fields 253e-253i with drop-down menus are presented for viewing and editing. Data entry field 253e allows the selection of a SPI general class, or “Toddler/Preschool Toys” in FIG. 2C. SPI general classes describe categories of toys grouped around functional packaging requirements, which have been analyzed from the packaging of over 500 toy products. Accordingly, products in the same SPI general class will have similar functional packaging requirements.

Data entry field 253f allows the selection of a SPI size class, or “Small” in FIG. 2C. SPI size classes describe the general size range of the packaging; the larger the size range, the more packaging required. Presently, five size classes are utilized: “Micro” for 0-250 cubic cm, “Small” for 251-2500 cubic cm, “Medium” for 2501-8000 cubic cm, “Large” for 8001-45000 cubic cm, and “Oversize” for 45001-100000 cubic cm.

Data entry field 253g allows the selection of a SPI quantity class, or “1 Toy” in FIG. 2C. SPI quantity classes describe the number of items to be included in the packaging, for example a single toy, a single toy plus accessories, or a multi-pack or multi-piece play set. Depending on the quantity class, available packaging options may be simplified or expanded.

Data entry field 253h allows the selection of a SPI storage class, or “No Storage” in FIG. 2C. SPI storage classes describe whether an enclosing storage container is included with the packaging that can be reused; for example, a box to hold puzzle pieces, a box for board games, a plastic storage case for action figure sets, and other containers. If such a container is included, the SPI storage class may be “Storage”. Otherwise, if no such container is included, the SPI storage class may be “No Storage.”

Although data entry field 253e may describe a wide range of general-purpose product classes, some products have unique packaging requirements that do not neatly fit into the SPI general classes. In this case, data entry field 253i may be utilized to specify a SPI special class. As shown in FIG. 2C, data entry field 253i is set to “General”, indicating that the present product and scenario does not utilize a SPI special class. However, for products that require a SPI special class, data entry field 253i may be utilized to select a SPI special class. Examples of SPI special classes include 1) consumer electronics, which may require additional theft-deterrence functionality, 2) media such as CDs, DVDs, and Blu-ray discs, which may require only minimal packaging, 3) flat items, which open up a specific range of packaging solutions, 4) products with assembly required or 5) bicycles or ride-ons, which are typically packaged in closed corrugated cardboard boxes, and 6) soft wearable items or 7) plush toys, which can be merchandized with minimal packaging since there is low risk of damage and customers may desire to touch the product. If a SPI special class is selected in data entry field 253i, then data entry field 253e may be grayed out and disabled until data entry field 253i is returned to “General”.

Accordingly, by using the SPI classification system as summarized in FIG. 2C, products can be placed in classes with very similar functional packaging requirements, regardless of the specific toy genre or traditional retail classification of the product. Thus, even if two products may be shelved in different aisles of a retailer and may typically be categorized as separate groups, if the two products have similar functional packaging requirements, they will belong to the same SPI class grouping. Presently, by adjusting data entry fields 253e-253i, the scenario may be categorized within one of 21 unique SPI class groups for the purposes of industry product comparison. However, the SPI class groups may be expanded or narrowed based on varying environmental requirements, industry standards, system constraints, or other changing needs. The SPI classification system therefore provides a powerful tool by which products can be compared to other products with similar packaging requirements, allowing the establishment of an industry norm for a particular SPI class based on packaging data for existing industry products.

For example, referring back to FIG. 1, external materials database 142 may contain material information, such as carbon footprint data, materials health data, and waste-to-landfill data. For example, for a certain material used in packaging, external materials database may contain information related to the carbon footprint of the material, such as grams of carbon dioxide emissions over the life-cycle of the material. As used herein, materials health represents an estimate of the toxicity emissions, which may affect humans, that are released into the environment during package production and disposal. Thus, it is not a measurement of the acute toxicity, such as by consumer handling, of the package. However, in other embodiments, external materials database 142 may contain information corresponding to the acute toxicity of the package if relevant and necessary to the particular SPI class. In addition, external materials database 142 may contain cube utilization data for similar packages. External materials database 142 may contain packaging data for existing and past product packages in the industry, which may then be sorted and organized according to the SPI classification system. However, in another embodiment, a separate database, such as SPI norms database 144, may perform the sorting and organizing according to SPI classification system.

Based on the material information and packaging data, external materials database 144 may contain a raw score for existing and past product packages. As used herein, a raw score represents an estimate for the potential life-cycle environmental impacts that results from the production of the package based on scope of the SPI indicators. For example, if the SPI scoring system for a particular SPI class requires an assessment of the carbon footprint, the materials health, the waste-to-landfill ratio, and the cube utilization, then the raw score represents a unit measurement for each indicator.

Thus, as explained above, external materials database 142 may contain information related to the life-cycle inventories of common packaging materials and end-of-life material estimates, such as assessments based on recycling, incineration, and landfill space of the materials. In the above implementation, the SPI scoring system may be concerned with the carbon footprint of the package, the materials health of the package, the cube utilization of the package, and the waste-to-landfill ratio of the package. In one implementation, external materials database 142 may be Life Cycle Impact Assessment values from the International Panel on Climate Change. Other sources may also constitute external materials database 142 or provide information compiled in external materials database 142.

Using the raw score for existing and past packages, SPI norms database 144 may determine an SPI score for a particular existing or past package. In one implementation, SPI norms database 144 may receive raw scores of existing and past packages designated for a particular SPI class. However, as explained above, SPI norms database 144 may also receive raw scores for existing and past packages and organize the packages into SPI classes based on an SPI classification system.

Once the raw scores for existing and past packages are organized into SPI classes, SPI norms database may apply a normalized curve to the raw scores. The normalized curve applied by the SPI norms database may depend on the SPI class and the SPI scoring system. For example, based on the raw score for a particular existing package, the carbon footprint may be scored on a scale of 0-100 based on a normalized curve as compared to other industry packages. Thus, the carbon footprint of the particular existing package in an SPI class may be given a measure, such as 80/100, comparative to the industry.

Once a measure is given to each SPI indicator, the SPI scoring system may determine a SPI score for each particular existing or past package based on the proportion of each SPI indicator that contributes to the score. In the previous example, the carbon footprint SPI indicator may contribute 30% to the SPI score. The SPI score may be made up of percentage amounts of each SPI indicator. Thus, SPI norms database 144 is populated with SPI scores by normalizing the raw scores for each SPI class in the SPI classification system and weighing the individual indicators according to an SPI scoring system.

In the present implementation, SPI norms database 144 is static based on the normalized raw scores of existing and past packages. However, SPI norm database 144 may also be dynamic and updated with new raw scores. New raw scores may be new information added to external materials database, such as new industry packages. New raw scores may also include a raw score of a package submitted by user 130, as described next.

When new product package designs are created and added to compiled product SPI database 140 through user entry in SPI Application 128, compiled product SPI database 140 may access external materials database 142. In one implementation, user 130 may enter information in data entry fields 253e-253i of FIG. 2C and added to compiled product database 140. Based on this information, a raw score may be calculated for the new product package design using external materials database 142. For example, from the information entered in data entry fields 253e-253i, a raw score for the carbon footprint may be determined based on information, such as materials data, contained in external materials database 142.

Once a raw score is determined for the new product package design, SPI norms database 144 may determine an SPI score for the new product package design. SPI norms database 144 may receive the raw score for the new product package design designating a particular SPI class. However, in other embodiments, SPI norms database 144 may determine the SPI class for the new product package design. Based on the SPI class, the raw score of the new product package design may be given an SPI score based on the normalized scores of industry existing and past package designs in SPI norms database 144. As previously explained, an industry average curve for environmentally friendly packaging may be established according to SPI class groupings. Referring to FIG. 2A, a comparison to the industry average curve can be seen under the “Industry Norm” column. If the SPI score of the new packaging scenario is consistent with existing industry norms, then “Industry Norm” may be listed. Otherwise, “Above Norm” or “Below Norm” may be shown if the new packaging scenario is higher or lower than existing industry norms, providing a useful point of reference whether certain package design scenarios are meeting target goals or are in need of additional revisions.

Although not specifically shown in the Figures, tabbed windows 256f, 256h, and 256h may appear similar to tabbed windows 256d and 256e shown in FIGS. 2B and 2C, respectively. That is, each tabbed window 256f-256h may include a variety of data entry widgets for entering in product data within the respective data groupings, or “Package Size”, “Package Components”, and “Q&A”.

While data entry field 253f provides a general size range of the product package, tabbed window 256f or “Package Size” may allow user 130 to specify in greater detail the specific dimensions of the envisioned product package. User 130 can further refine the estimate by explicitly specifying package dimensions including height, width, and depth. User 130 may also specify a master carton size used to deliver the product in the package, and the number of packages per master carton. Further, user 130 may enter cube utilization corresponding to the placement of the product within the package. Cube utilization may be estimated through determining the number of products and/or accompanying accessories that could fit within the package.

Tabbed window 256g or “Package Components” may allow user 130 to specify in greater detail the specific material makeup of the envisioned product package. User 130 can add details for each component that makes up the product packaging, including a component name, a component type or class, a quantity, a material type such as cardboard or plastic, a conversion, and an amount. The component name is a user-defined field to identify the component. The component type is an optional selection of commonly used materials, which may populate some of the remaining fields automatically for the user. The quantity, if applicable, refers to the quantity of similar components required, and may be set to 1 as default. However, the package may require multiple similar hang tags or windows of the same dimensions and/or materials, and thus can be grouped together. The material type describes the material makeup of the component. The conversion describes any conversions the material undergoes; for example, cardboard may be converted into a box or carton. The amount describes the mass of the component, and may be provided directly from a supplier or calculated using various helper calculators. For example, a paper calculator may calculate paper mass based on desired paper size and material strength, a blister calculator may calculate plastic mass based on a desired surface area and thickness, a plastic extrusion calculator may calculate resin mass based on a desired size and thickness, and a small part calculator may calculate weight of small parts, such as J-hooks, dennison tags, plastic elastics, and plastic coated wire, based on quantity and length of the small components incorporated in the package design.

Tabbed window 256h or “Q&A” may allow user 130 to answer a series of questions regarding the environmental sustainability of the package. One question may concern the ease of material separations, or whether an end-user can easily separate the different materials of the package for proper disposal or recycling. Another question may concern the ease of package recycling: for example, whether the packaging is free from hot melt adhesives, whether the packaging uses fiber-based fasteners, whether the paper materials are free of plastic or metal coatings, and whether inks are vegetable-based inks. Another question may concern whether any paper and board materials are certified by forest management certifications, and if not, a percentage of any non-certified recycled materials. Another question may concern if the paper or board pulp are from a known source origin. Additional questions may be added to tabbed window 256h to address various other environmental considerations.

Once all required data is entered into each of tabbed windows 256d-256h, a button may be provided to allow user 130 to calculate the SPI score for the present scenario. Assuming user 130 clicks on the button to calculate the SPI score, display 218c may transition to a user interface similar to that shown in display 218d of FIG. 2D. FIG. 2D presents an exemplary score report interface of the smart packaging initiative (SPI) scoring system. Display 218d of FIG. 2D includes tabbed window 256i. Tabbed window 256i includes buttons 254d, 254e and 254f, score meter 260, and score table 270. With respect to FIG. 2D, display 218d may correspond to display 118 from FIG. 1.

As previously discussed, each product package may be placed in a specific SPI class for comparison with other industry product packages in the same SPI class. Based on available data within raw score package database 142 for products in the same SPI class, an average industry norm range of 40-60 may be calculated for the present SPI class. Thus, 50% of industry products in the same SPI class use packages that fall between a 40-60 SPI score. The industry norm range may constitute a different range, such as 43-70, based on factors such as individual indicators or weights attached to each indicator. This range is reflected in score meter 260, which also shows the performance of the present scenario in comparison to industry norms. Score table 270 provides a breakdown of the SPI score. As shown in FIG. 2D, the score is broken down into four categories: carbon footprint at 30% weighting, materials health at 30% weighting, waste-to-landfill at 30% weighting, and cube utilization at 10% weighting. The score breakdown and weighting shown in FIG. 2D is only one exemplary breakdown, and alternative breakdowns and weightings may be utilized based on changing company ecological priorities, updated scientific data, updated product and/or materials data in external materials database 142, updated SPI classes and/or SPI scoring system, and other trends.

Examining the exemplary breakdown of score table 270 more closely, carbon footprint may measure the contribution of the packaging towards global climate change on a life-cycle basis. A life-cycle basis may examine the environmental impacts of the packaging from extracting, processing, and converting the raw material into the package, to the end-of-life fate, such as landfill refuse, incineration, or recycling of the package. More specifically, the International Panel on Climate Change's IPCC 2007 impact model may be utilized, weighing greenhouse emissions of greenhouse gases (GHGs) on a 100-year time scale, returning a value of kilograms of carbon dioxide equivalent or GHG emissions. Materials health measures the diffuse health impacts on people by tracking the emissions of chemicals released in manufacturing and the disposal of packaging materials, again on a life-cycle basis. Materials health may use the USEtox model to estimate human health effects. Waste-to-landfill measures the amount of materials in the packaging that reach end-of-life in landfills in the municipal solid waste system, using a non-life cycle basis. An estimated rate of diversion from the landfill is created in three steps: 1) Determining ease of separation for recycling or waste-to-energy conversion, 2) Determining the presence or absence of contaminants that may affect the recycling stream, and 3) Applying average recycling and waste to energy rages as applicable for different types of materials. Cube utilization measures, on a non-life cycle basis, the amount of space the product occupies relative to the packaging, penalizing excessive packaging relative to the size of the product. All of the data provided in tabbed windows 256d-256h, external materials database 142, and SPI norms database 144 may be utilized to calculate the components of score table 170. Additionally, the weightings of each indicator towards each score may be stored and updated in compiled product SPI database 140 and/or SPI norms database 144 and multipliers may be applied and adjusted as necessary to adjust the impact of each specific indicator.

Note that while the above SPI score includes the impact of the initial raw materials, any raw material conversions, and the packaging end-of-life stage, the above SPI score does not include the effects of product fulfillment, transport, or customer/end-user usage. However, the SPI score may be flexibly adjusted based on the specific priorities of the company utilizing the system. Thus, if the company also controls logistics and the product supply chain, then fulfillment and transport may be introduced as a larger factor into the SPI score. If the lifetime energy use of the product is to be considered, then customer/end-user usage may also be added as a SPI score element.

If user 130 is not satisfied with the calculated SPI score, button 254f or “Improve my Score” may be clicked, which may provide specific advice on how to improve or increase the SPI score. Information for improving the SPI score may include information from prior projects in compiled product SPI database 140 or information from external materials database 142. For example, since the cube utilization is low at 10/100, clicking on button 254f may provide information regarding alternative packaging formats, layouts, and presentations that conserve space, requiring less wasted material. While in FIG. 2D, advice for score improvement is only given after the score report is presented, in alternative implementations, advice for score improvement may be given dynamically while data entry is taking place, prior to the score report.

If user 130 wants a more granular breakdown of the SPI score composition, button 254e or “Retrieve Detailed Report” may be selected, providing a detailed listing of each element contributing to the SPI score. The detailed report may include a percentage of the overall environmental impact generated by each individual package components for easy identification. Finally, if user 130 is satisfied with the SPI score result, then button 254d may be clicked to submit the scenario for consideration. After a submission, the status of the scenario may be updated to “Submitted”, preventing any further changes to the scenario. Once the scenario is submitted, it may be sent to an approving reviewer. Additionally, once the scenario is submitted and/or approved the scenario and SPI score result may be saved in compiled product SPI database 140 for later recall. This may allow users to view past scenarios for comparison and/or use.

Furthermore, as previously described, a comparative report may also be generated using button 254a in FIG. 2A and past scenarios from compiled product SPI database 140. In this case, tabbed window 256i may display a comparative score report, where a score meter 260 may be shown for each selected scenario, and where a column may be provided in score table 270 for each selected scenario. In this manner, the comparative merits of each scenario can be readily analyzed at a glance, which may help to design a scenario that combines the merits of each scenario while minimizing the disadvantages.

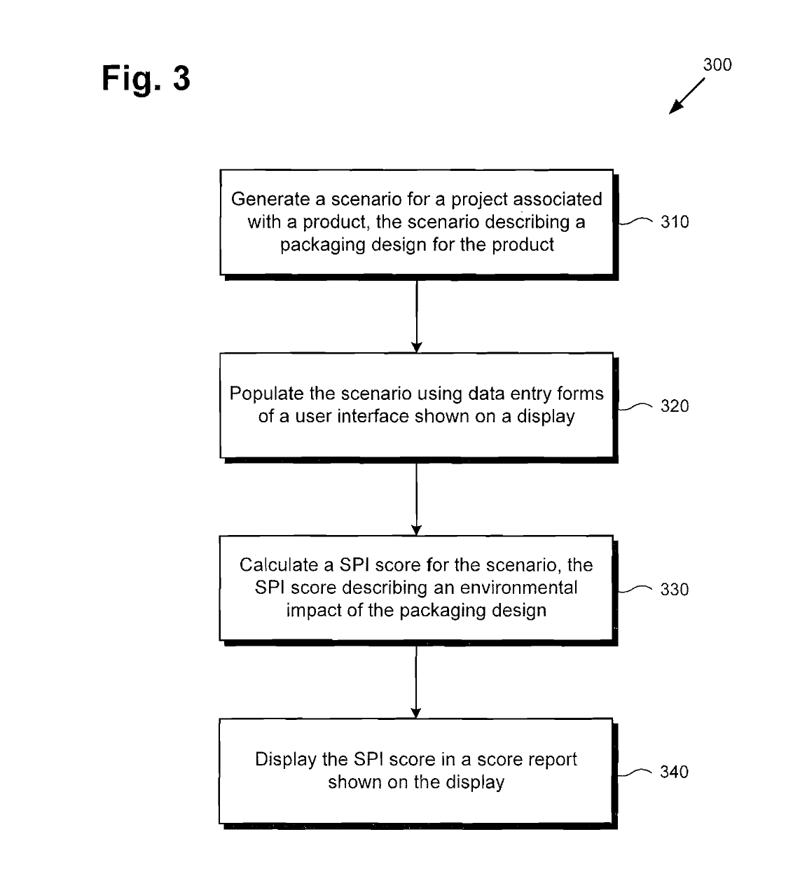

FIG. 3 presents an exemplary flowchart illustrating a method by which a user interface for the smart packaging initiative (SPI) scoring system may be provided. Flowchart 300 begins when processor 122 of server 120 generates a scenario for a projected associated with a product, the scenario describing a packaging design for the product (block 310). For example, user 130 may access SPI application 128 over network 135 via web browser 116. Assuming that record 252c has not yet been created, user 130 may click on button 254b of display 218a, and provide the name of a new scenario as shown in display 218b of FIG. 2B. Thus, the scenario “Blister Pack Ver. A” is created for the project “Action Figure #2222” associated with product 132, which may be an action figure of Spider-Man aimed at young children. “Blister Pack Ver. A” describes one specific packaging scenario applicable to product 132. As previously described, each project may include multiple scenarios to encourage experimentation and trial-and-error improvement of packaging designs, particularly when combined with the scenario comparison feature as provided by button 254a.

Next, processor 122 of server 120 populates the scenario using data entry forms of tabbed windows 256d-256h shown on display 118 (block 320). Accordingly, user 130 may view and edit the data entry forms presented on each of tabbed windows 256d-256h to populate the scenario with the relevant data. For example, for tabbed window 256d, data entry forms 253a-253d may be filled out by user 130, and for tabbed window 256e, data entry forms 253e-253i may be filled out by user 130.

Next, processor 122 of server 120 calculates a SPI score for the scenario, the SPI score describing an environmental impact of the packaging design (block 330). As previously discussed, the SPI score may be formulated based on company priorities and may change as time progresses and new data becomes available. As one non-limiting example, an example breakdown of the SPI score is shown in score table 270 of FIG. 2D, as discussed in greater detail above.

Next, processor 122 of server 120 shows the SPI score in a score report shown on display 118 (block 340). The score report may appear similar to the interface shown on display 218d of FIG. 2D. From here, user 130 is given several options, including soliciting suggestions for improvement (button 254f), retrieving a detailed score report (button 254e), or submitting the scenario for final consideration (button 254d). Additionally, user 130 may perform a comparative score report by using button 254a as shown in FIG. 2A. Accordingly, user 130 can be guided towards environmentally preferable packaging designs to achieve environmental goals for sustainability.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the spirit and the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A computing device for providing access to the smart packaging initiative (SPI) scoring system, the computing device comprising:
a processor configured to:
generate a scenario for a project associated with a product, the scenario describing a packaging design for the product;
populate the scenario using data entry forms of a user interface shown on a display;
calculate a SPI score for the scenario, the SPI score describing an environmental impact of the packaging design;
display the SPI score in a score report shown on the display.

2. The computing device of claim 1, wherein said SPI score includes a carbon footprint of the packaging design on a life-cycle basis.

3. The computing device of claim 1, wherein said SPI score includes a materials health of the packaging design on a life-cycle basis.

4. The computing device of claim 1, wherein said SPI score includes a waste-to-landfill measurement of the packaging design.

5. The computing device of claim 1, wherein said SPI score includes a cube utilization of the packaging design.

6. The computing device of claim 1, wherein said product is classified according to a SPI class group.

7. The computing device of claim 6, wherein said SPI class group includes a SPI size class, a SPI quantity class, and a SPI storage class.

8. The computing device of claim 1, wherein displaying said SPI score further compares said SPI score to SPI scores of other products in a same SPI class group within a same industry.

9. The computing device of claim 1, wherein displaying said SPI score further compares said SPI score to SPI scores of other scenarios in the project.

10. The computing device of claim 1, wherein displaying said SPI score further shows advice to increase the SPI score.

11. A method for providing access to the smart packaging initiative (SPI) scoring system, the method comprising:
generating a scenario for a project associated with a product, the scenario describing a packaging design for the product;
populating the scenario using data entry forms of a user interface shown on a display;
calculating a SPI score for the scenario, the SPI score describing an environmental impact of the packaging design;
displaying the SPI score in a score report shown on the display.

12. The method of claim 11, wherein said SPI score includes a carbon footprint of the packaging design on a life-cycle basis.

13. The method of claim 11, wherein said SPI score includes a materials health of the packaging design on a life-cycle basis.

14. The method of claim 11, wherein said SPI score includes a waste-to-landfill measurement of the packaging design.

15. The method of claim 11, wherein said SPI score includes a cube utilization of the packaging design.

16. The method of claim 11, wherein said product is classified according to a SPI class group.

17. The method of claim 11, wherein said SPI class group includes a SPI size class, a SPI quantity class, and a SPI storage class.

18. The method of claim 11, wherein displaying said SPI score further compares said SPI score to SPI scores of other products in a same SPI class group within a same industry.

19. The method of claim 11, wherein displaying said SPI score further compares said SPI score to SPI scores of other scenarios in the project.

20. The method of claim 11, wherein displaying said SPI score further shows advice to increase the SPI score.
